(19) United States
(12) Patent Application Publication
(10) Pub. No.: US 2022/0408463 A1
(43) Pub. Date: Dec. 22, 2022

(54) USER EQUIPMENT AND METHOD OF COMMUNICATION OF SAME

(71) Applicant: .OROPE FRANCE SARL, Neuilly-sur-Seine (FR)

(72) Inventor: Hao LIN, Neuilly sur Seine (FR)

(21) Appl. No.: 17/894,915

(22) Filed: Aug. 24, 2022

Related U.S. Application Data
(63) Continuation of application No. PCT/IB2020/000453, filed on Feb. 24, 2020.

(51) Int. Cl. H04W 72/12; H04W 76/20

(52) U.S. Cl. CPC H04W 72/1268; H04W 76/20; H04W 72/1289

(57) ABSTRACT

A user equipment (UE) and a method of communication of the same are provided. The method includes receiving, by a UE, a first information and a second information, wherein the first information and the second information are used to determine a frequency location of a physical uplink control channel (PUCCH). This provides PUCCH resource allocation determination.

### CROSS-REFERENCE TO RELATED APPLICATION

This is a continuation application of International Patent Application No. PCT/IB2020/000453, filed on Feb. 24, 2020, the disclosure of which is hereby incorporated by reference in its entirety.

### BACKGROUND OF DISCLOSURE

### 1. Field of the Disclosure

The present disclosure relates to the field of communication systems, and more particularly, to a user equipment (UE) and a method of communication of the same, which can provide a good communication performance and high reliability.

### 2. Description of the Related Art

In an unlicensed band, an unlicensed spectrum is a shared spectrum. Communication equipments in different communication systems can use the unlicensed spectrum as long as the unlicensed meets regulatory requirements set by countries or regions on a spectrum. There is no need to apply for a proprietary spectrum authorization from a government.

In order to allow various communication systems that use the unlicensed spectrum for wireless communication to coexist friendly in the spectrum, some countries or regions specify regulatory requirements that must be met to use the unlicensed spectrum. For example, a communication device follows a listen before talk (LBT) procedure, that is, the communication device needs to perform a channel sensing before transmitting a signal on a channel. When an LBT outcome illustrates that the channel is idle, the communication device can perform signal transmission; otherwise, the communication device cannot perform signal transmission. In order to ensure fairness, once a communication device successfully occupies the channel, a transmission duration cannot exceed a maximum channel occupancy time (MCOT).

In new radio-based access to unlicensed spectrum (NRU), a wideband operation can be configured and a configured active bandwidth part (BWP) can include resource block sets (RB sets). Physical uplink control channel (PUCCH) resource allocation in terms of an RB set and an interlace is not fully designed and is still an open issue.

In addition, in an NRU wideband operation, a BS (such as gNB) and a UE can operate in a wider band including RB sets. NR release 15 has defined a BWP concept, thus in a context of the NRU wideband operation, the UE can be configured with an active BWP including multiple RB sets. However, by regulation, priori to each transmission in the spectrum, a sender needs to perform the LBT procedure. This implies that for transmissions of multiple RB sets, multi-RB set-based LBT has to be performed. Because an outcome of the multi-RB-set based LBT cannot be ensured, the UE or the BS cannot predict the outcome of the LBT procedure.

Therefore, there is a need for a user equipment (UE) and a method of communication of the same, which can solve issues in the prior art, determine a frequency location of a physical uplink control channel (PUCCH), and provide PUCCH resource allocation determination.

### SUMMARY

An object of the present disclosure is to propose an apparatus (such as a UE and/or a BS) and a method of communication of the same, which can solve issues in the prior art, allow the apparatus to determine a channel state of a first bandwidth of a cell, and may further allow the apparatus to determine RB set availability of an active BWP based on the channel state of the first bandwidth.

In a first aspect of the present disclosure, a method of communication of a user equipment (UE) includes receiving, by a UE, a first information and a second information, wherein the first information and the second information are used to determine a frequency location of a physical uplink control channel (PUCCH).

In a second aspect of the present disclosure, a UE includes a memory, a transceiver, and a processor coupled to the memory and the transceiver. The processor is configured to control the transceiver to receive a first information and a second information, wherein the first information and the second information are used to determine a frequency location of a physical uplink control channel (PUCCH).

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an interlaced structure for an uplink channel transmission.

FIG. 2 is a block diagram of a user equipments (UE) and a base station (BS) (e.g., gNB) of communication in a communication network system according to an embodiment of the present disclosure.

FIG. 3 is a flowchart illustrating a method of communication of a UE according to an embodiment of the present disclosure.

FIG. 4 is a schematic diagram illustrating relation between a cell usable bandwidth and an active uplink bandwidth part (UL BWP) according to an embodiment of the present disclosure.

FIG. 5 is a schematic diagram illustrating a cell usable bandwidth according to an embodiment of the present disclosure.

FIG. 6 is a schematic diagram illustrating a cell usable bandwidth according to another embodiment of the present disclosure.

FIG. 7 is a schematic diagram illustrating a cell usable bandwidth and an active uplink bandwidth part (UL BWP) according to an embodiment of the present disclosure.

FIG. 8 is a schematic diagram illustrating a cell usable bandwidth and an active uplink bandwidth part (UL BWP) according to another embodiment of the present disclosure.

FIG. 9 is a schematic diagram illustrating physical uplink control channel (PUCCH) resource allocation determination according to another embodiment of the present disclosure.

FIG. 10 is a schematic diagram illustrating PUCCH resource allocation determination according to another embodiment of the present disclosure.

FIG. 11 is a schematic diagram illustrating PUCCH resource allocation determination according to another embodiment of the present disclosure.

FIG. 12 is a schematic diagram illustrating PUCCH resource allocation determination according to another embodiment of the present disclosure.

FIG. 13 is a schematic diagram illustrating PUCCH resource allocation determination according to another embodiment of the present disclosure.

FIG. 14 is a schematic diagram illustrating PUCCH resource allocation determination according to another embodiment of the present disclosure.

FIG. 15 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

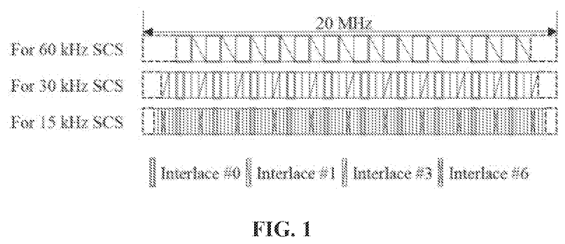

FIG. 1 illustrates an interlaced structure for an uplink channel transmission. In new radio-based access to unlicensed spectrum (NRU) physical uplink control channel (PUCCH) interlace, in an unlicensed band in 5G Hz, a regulation imposes that if a transmitter wants to operate transmission in a channel, the transmission has to occupy at least 80% of a channel bandwidth. With this restriction, NRU decided to adopt an interlaced structure for two uplink channel transmissions, they are PUCCH and physical uplink shared channel (PUSCH). Each interlace structure will have specific number of physical resource block (PRB). Between each consecutive PRB pairs, there is M PRB further apart. For example, in a 20 MHz bandwidth and for 30 kHz subcarrier spacing (SCS) case, 1 interlace has 10 or 11 PRBs and M=5.

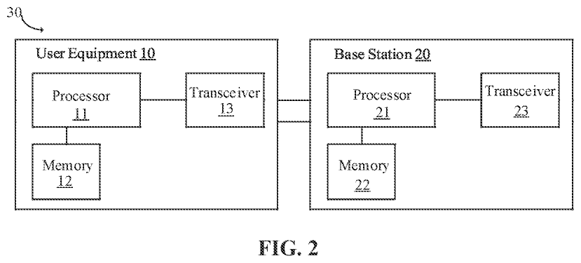

FIG. 2 illustrates that, in some embodiments, a user equipment (UE) 10 and a base station (BS) (e.g., gNB) 20 of communication in a communication network system 30 according to an embodiment of the present disclosure are provided. The communication network system 30 includes one or more UEs 10 of a cell and the BS 20. The UE 10 may include a memory 12, a transceiver 13, and a processor 11 coupled to the memory 12, the transceiver 13. The base station 20 may include a memory 22, a transceiver 23, and a processor 21 coupled to the memory 22, the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of first information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

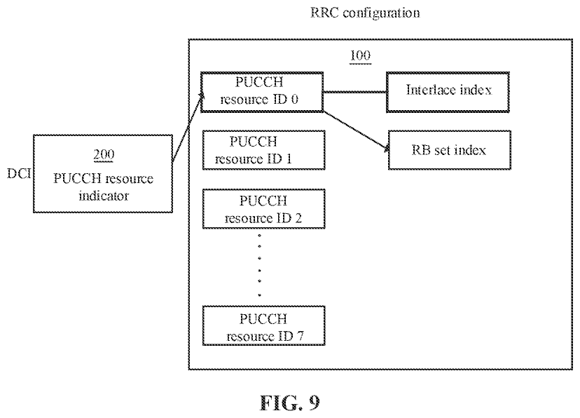

In some embodiments, the processor 11 is configured to control the transceiver 13 to receive a first information and a second information, wherein the first information and the second information are used to determine a frequency location of a physical uplink control channel (PUCCH) (to be described in detail in FIG. 9 to FIG. 14). This can determine the frequency location of the PUCCH and provide PUCCH resource allocation determination.

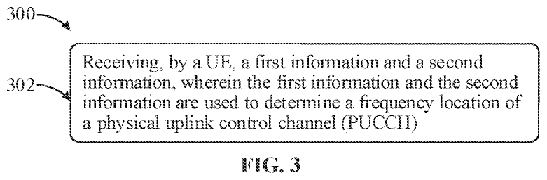

FIG. 3 illustrates a method 300 of communication of a UE according to an embodiment of the present disclosure. In some embodiments, the method 300 includes: a block 302, receiving, by a UE, a first information and a second information, wherein the first information and the second information are used to determine a frequency location of a physical uplink control channel (PUCCH) (to be described in detail in FIG. 9 to FIG. 14). This can determine the frequency location of the PUCCH and provide PUCCH resource allocation determination.

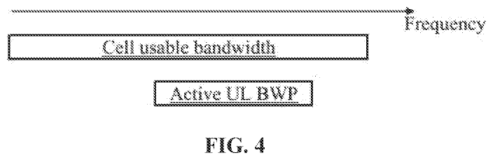

FIG. 4 illustrates relation between a cell usable bandwidth and an active uplink bandwidth part (UL BWP) according to an embodiment of the present disclosure. In some embodiments, in a wideband transmission in an unlicensed spectrum operation, a UE can be configured with an active downlink or uplink bandwidth part (DL or UL BWP) that includes one or more resource block sets (RB sets). During data reception, it is important for the UE to know if the configured RB sets in the active DL BWP is available for reception. The availability means that a gNB has performed listen before talk (LBT) for each RB set, and there is no other transmissions ongoing so that the gNB will gain a channel for transmission, i.e. LBT success; otherwise the RB set is not available for the gNB to transmit any signal, i.e. LBT failure. If it is known to the UE that the RB set is not available, the UE will not perform signal reception in the RB set.

FIG. 4 illustrates that, in some embodiments. RB sets are used in two different contexts. FIG. 4, gives a relation between the cell usable bandwidth and an active UL BWP. It can be that, one or more RB sets are in a cell usable bandwidth of a given cell. Note that the cell usable bandwidth including an active UL BWP and the active UL BWP is a part of the cell usable bandwidth. For example, the given cell is the same as a cell where the UE is located. In some embodiments, the given cell is a serving cell.

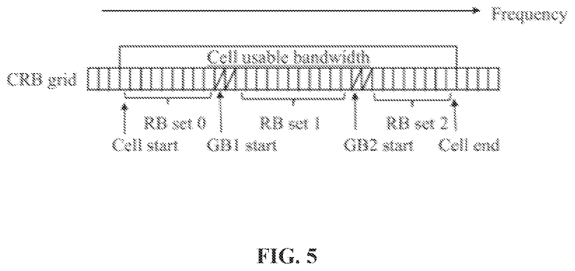

FIG. 5 illustrates a cell usable bandwidth according to an embodiment of the present disclosure. In some embodiments, for RB sets in a cell usable bandwidth of a cell, a UE can derive a number of RB sets, RB set indexes, and locations of the RB sets by a location of the cell usable bandwidth and intra-cell guard bands. One example is illustrated in FIG. 5, where the cell usable bandwidth is defined in a common RB (CRB) grid with a starting CRB index and a cell usable bandwidth size (in terms of RB). Then, the UE will first determine a cell usable bandwidth location. After that, the UE will obtain intra-cell guard band information which contains a number of intra-cell guard bands and a location and a size of each intra-cell guard band (GB). In an example, the intra-cell guard band information provides two guard bands (i.e. GB1 and GB2), a starting GB position and a guard band size (in terms of RB) are also given. The starting position of a GB can be given with CRB index (In the example, both GB1 and GB2 have the same GB size of 2 RBs). Then, the cell usable bandwidth is divided into 3 RB sets with RB set index from 0 to 2. The RB set index is ordered in an ascending order in a frequency domain, i.e. index 0 in lower frequency and index 2 in higher frequency. Note that to achieve the same or similar result, the intra-cell guard band information can contain GB starting CRB index and ending CRB index as well instead of GB size.

In some embodiments, the UE can obtain the intra-cell guard band information by following ways.

1. The intra-cell guard band information can be provided by the gNB to the UE via a radio resource control (RRC) configuration with a dedicated parameter of intraCellGuardBandUL-r16 for uplink.

2. If the parameter intraCellGuardBandUL-r16 is not provided by the gNB, the UE can also derive the RB sets in the cell usable bandwidth by pre-defined intra-cell guard band information from the specifications.

3. If the parameter intraCellGuardBandUL-r16 is provided to the UE, but the parameter indicates a guard band with zero guard band size, the UE derives the RB sets in the cell usable bandwidth by pre-defined intra-cell guard band information from the specifications.

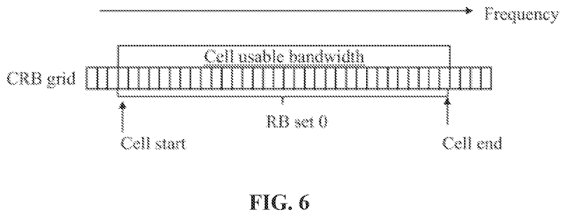

4. If the parameter intraCellGuardBandUL-r16 is provided to the UE, but the parameter indicates a guard band with zero guard band size, the UE determines the cell usable bandwidth has one RB set with index 0 as illustrates in FIG. 6.

FIG. 6 illustrates a cell usable bandwidth according to another embodiment of the present disclosure. In some embodiments, the provided intra-cell guard band information indicating a zero guard band size can be realized by either directly indication of guard band size is 0, or derived from the ending position CRB index is smaller than the starting position CRB index, this causes CRB index (ending)-CRB index (starting) to be a negative value. In this embodiment, it means that GB does not exist, so that the cell usable bandwidth includes only one RB set whose index is 0. In some embodiments, the RB set has index 0. In some embodiments, a size of the RB set in cell usable bandwidth is equal to a size of cell usable bandwidth.

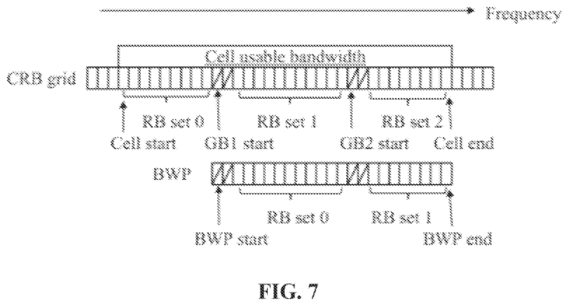

FIG. 7 illustrates a cell usable bandwidth and an active uplink bandwidth part (UL BWP) according to an embodiment of the present disclosure. In some embodiments, for RB sets in an active UL BWP, a UE first determines a location of the active UL. To do this, the UE will be provided by a gNB with BWP configuration, which includes a BWP starting position (in CRB index) and a BWP size (in terms of RB). Then, the UE can derive BWP starting and end positions as illustrated in FIG. 7. Once the active UL BWP is determined, intersection between the active BWP and the cell usable bandwidth can give the RB sets in the active BWP. FIG. 7 illustrates that, in some embodiments, the active BWP overlaps with RB set 1 and RB set 2 of the cell usable bandwidth. Thus, the UE determines there are two RB sets in this active BWP. The RB set index is ordered from 0 to 1 in the active BWP in an ascending order in the frequency domain. The advantage of indexing the RB sets in active BWP from 0 is to ease the frequency domain resource allocation (FDRA) since the reference starting index of the FDRA is usually from 0.

In some embodiments, the indexes and locations of the RB sets in the cell usable bandwidth are obtained based on the parameter and the cell usable bandwidth. In some embodiments, a size of each of the RB sets (RB set 1, RB set 2, or RB set 3) in the cell usable bandwidth is less than a size of the cell usable bandwidth. In some embodiments, a sum of a size of the RB sets (RB set 1, RB set 2, and RB set 3) in the cell usable bandwidth and a size of the one or more guard bands (GB 1 and GB 2) in the cell usable bandwidth is equal to the size of the cell usable bandwidth.

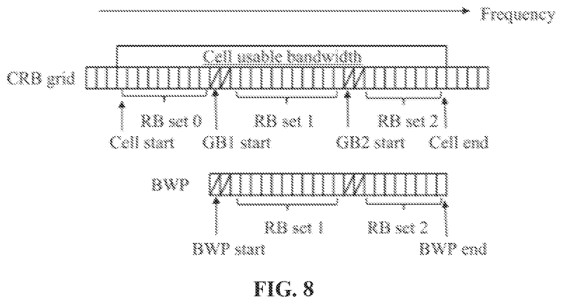

FIG. 8 is a schematic diagram illustrating a cell usable bandwidth and an active uplink bandwidth part (UL BWP) according to another embodiment of the present disclosure. In some embodiments, alternatively, an RB set index in an active BWP can also follow the same index of RB sets in a cell usable bandwidth part as illustrated in FIG. 8. In FIG. 8, since the RB set index is not changed from the cell usable bandwidth to the active BWP, the RB set index in the active BWP can be derived directly from the same RB set index in the cell usable bandwidth. The advantage is that it eases for a UE to determine the RB set index in the active BWP directly from the same RB set index in the cell usable bandwidth.

In some embodiments, it is assumed that, there are Y RB sets in the cell usable bandwidth of the cell. If FIG. 6 is used as an example, Y=1 and if FIG. 7 and FIG. 8 are used as examples, Y=3.

FIG. 9 illustrates PUCCH resource allocation determination according to another embodiment of the present disclosure. A UE receives a first information 100 and a second information 200, and the first information 100 and the second information 200 are used to determine a frequency location of a physical uplink control channel (PUCCH). This can determine the frequency location of the PUCCH and provide PUCCH resource allocation determination.

FIG. 9 illustrates that, in some embodiments, the first information 100 is in a radio resource control (RRC) configuration. In some embodiments, the first information 100 comprises at least two configurations with corresponding configuration indexes (such as PUCCH resource identities 0 to 7). In some embodiments, each configuration of the first information 100 comprises a first parameter, the first parameter is used to indicate a interlace index corresponding to a selected interlace. In some embodiments, each configuration of the first information 100 further comprises a second parameter, the second parameter is used to indicate a resource block (RB) set index corresponding to a selected RB set. In some embodiments, the second information 200 is in a downlink control information (DCI). In some embodiments, the second information 200 comprises a first indication field (such as a PUCCH resource indicator), the first indication field is used to select one of the configuration indexes of the first information 100. For Example, the PUCCH resource indicator is used to select one of PUCCH resource identities (IDs). In an example, the PUCCH resource indicator selects PUCCH resource ID 0 from PUCCH resource ID 0 to 7.

FIG. 9 illustrates that, in some embodiments, when the UE needs to determine the PUCCH resource, the UE will receive the PUCCH resource indicator in a scheduling DCI. The PUCCH resource indicator contains 3 bits that can indicate one of the PUCCH resource identities 0 to 7. Each PUCCH resource identity corresponds to a PUCCH resource configuration. These configurations are RRC configured by a higher layer. In the PUCCH resource configuration, it includes an interlace index and an RB set index.

In some embodiments, the frequency location of the PUCCH is determined by overlapped RBs between the selected interlace and the selected RB set. In some embodiments, the RB set index is an index of the selected RB set in a cell usable bandwidth of a cell. In some embodiments, the RB set index in the cell usable bandwidth has indexes staring from 0 to X−1 in an ascending order in a frequency domain, where X is a number of RB sets in the cell usable bandwidth. In some embodiments, the RB set index and locations of the RB sets in the cell usable bandwidth are obtained based on a third parameter and the cell usable bandwidth. In some embodiments, the RB set index in the active uplink bandwidth part has indexes from 0 to Y−1 in an ascending order in a frequency domain, where Y is a number of the RB sets in the active uplink bandwidth part. In some embodiments, the selected RB set in the active uplink bandwidth part is derived from RB sets in a cell usable bandwidth of a cell and the active uplink bandwidth part.

In some embodiments, the RB set index and locations of the RB sets in the cell usable bandwidth are obtained based on a third parameter and the cell usable bandwidth. In some embodiments, the frequency location of the PUCCH is determined by overlapped RBs between the selected interlace and the selected RB set in the active uplink bandwidth part. In some embodiments, the third parameter is used to a location and a size of one indicate intra-cell guard band. In some embodiments, the third parameter is used to locations and sizes of at least two indicate intra-cell guard bands. In some embodiments, the location and the size of the intra-cell guard band are pre-defined, if the third parameter is not provided. In some embodiments, the location and the size of the intra-cell guard band are pre-defined, if the third parameter indicates the size of the intra-cell guard band is zero. In some embodiments, the cell usable bandwidth only contains one RB set with index 0, if the third parameter indicates the size of the intra-cell guard band is zero. In some embodiments, the PUCCH cannot use interlace, if the RB set with index 0 has a bandwidth exceeding a threshold. In some embodiments, the threshold depends on a carrier subcarrier spacing. In some embodiments, the threshold is pre-defined or in an RRC configuration. In some embodiments, the third parameter is in an RRC configuration. In some embodiments, the third parameter comprises intraCellGuardBandUL-r16 for uplink.

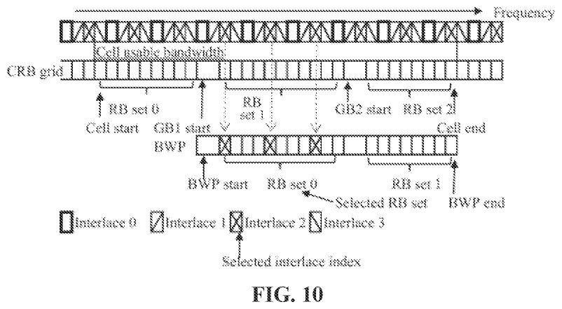

FIG. 10 illustrates PUCCH resource allocation determination according to another embodiment of the present disclosure. In some embodiments, an RB set index is an RB set index in an active UL BWP. The UE determines a selected PUCCH resource identity and further determines a selected interlace index and a selected RB set index. Then, the UE can finally determine the PUCCH resource as intersection between the RB in the selected interlace and the RB in the selected RB set. FIG. 10 illustrates that, in some embodiments, the selected PUCCH resource configuration indicates RB set 0 and interlace index 2. Then, the UE will determine the RB set 0 in the active UL BWP and further determine the RB of the interlace index 0 in the RB set 0 of the active UL BWP as the allocated PUCCH resource. In some embodiments, the frequency location of the PUCCH is determined by overlapped RBs between the selected interlace, the selected RB set, and an active uplink bandwidth part. The RB set index is ordered from 0 to 1 in the active BWP in an ascending order in the frequency domain. The advantage of indexing the RB sets in active BWP from 0 is to ease the frequency domain resource allocation (FDRA) since the reference starting index of the FDRA is usually from 0. In addition, the UE can determine the RB set in the active UL BWP directly.

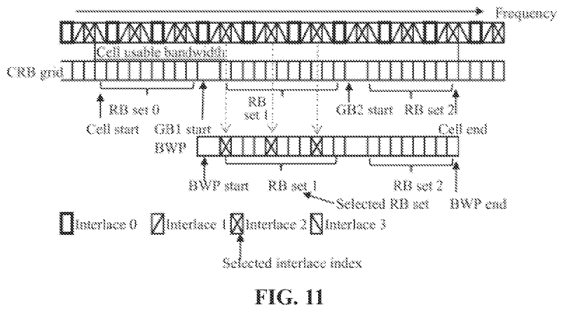

FIG. 11 illustrates PUCCH resource allocation determination according to another embodiment of the present disclosure. In some embodiments, an RB set index is an RB set index in an active UL BWP. The UE determines a selected PUCCH resource identity and further determines a selected interlace index and a selected RB set index. Then, the UE can finally determine the PUCCH resource as intersection between the RB in the selected interlace and the RB in the selected RB set. FIG. 11 illustrates that, in some embodiments, the selected PUCCH resource configuration indicates RB set 0 and interlace index 2. Then, the UE will determine the RB set 0 in the active UL BWP and further determine the RB of the interlace index 0 in the RB set 0 of the active UL BWP as the allocated PUCCH resource. In some embodiments, the frequency location of the PUCCH is determined by overlapped RBs between the selected interlace, the selected RB set, and an active uplink bandwidth part. In some embodiments, alternatively, an RB set index in an active BWP can also follow the same index of RB sets in a cell usable bandwidth part as illustrated in FIG. 11. In FIG. 11, since the RB set index is not changed from the cell usable bandwidth to the active BWP, the RB set index in the active BWP can be derived directly from the same RB set index in the cell usable bandwidth. The advantage is that it eases for a UE to determine the RB set index in the active BWP directly from the same RB set index in the cell usable bandwidth.

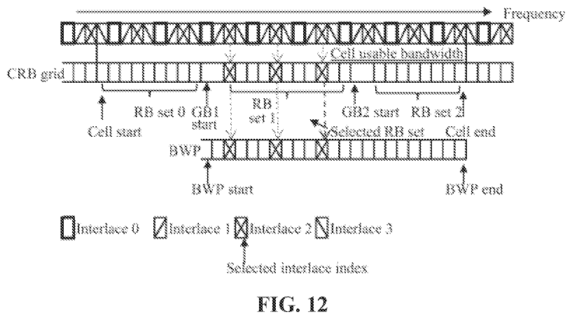

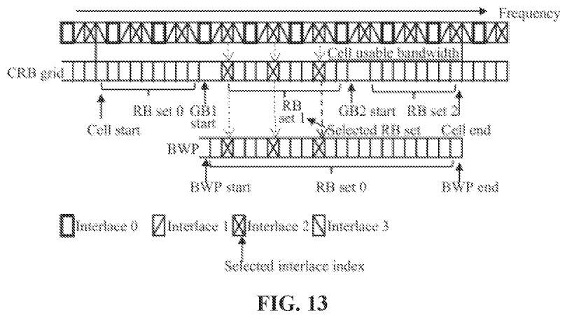

FIG. 12 illustrates PUCCH resource allocation determination according to another embodiment of the present disclosure. FIG. 13 illustrates PUCCH resource allocation determination according to another embodiment of the present disclosure. In some embodiments, the PUCCH configuration indicates the selected RB set index, but this RB set index is the RB set index in a cell usable bandwidth. The UE receives the selected interlace index and RB set index from the selected PUCCH resource identity. Then, the UE determines the PUCCH resource by the intersection of the RB of the selected interlace and the RB of the selected RB sets in the cell usable bandwidth and the RB of the active UL BWP, as illustrated in FIG. 12. In some embodiments, the active UL BWP does not RB set; or it only has one big RB set 0 which covers RB set 1 and RB set 2 of the cell usable bandwidth as illustrated in FIG. 13. Advantages of some embodiments in FIG. 12 and FIG. 13 are applicable to different UEs of a cell, because the different UEs of the cell will not differ in the cell usable bandwidth.

In some embodiments, in a special case where the cell usable bandwidth has one RB set, e.g. FIG. 6, if the bandwidth of the RB set 0 exceeds a pre-defined threshold. e.g. 20 Mhz or X resource blocks, where X is pre-defined and the value can be depending on different subcarrier spacings. Then, interlace structure cannot be used. This means that PUCCH using interlace structure (configured by useInterlacePUCCH-Common-r16, or useInterlacePUSCH-Common-r16 or useInterlacePDCCH-Common-r16 or useInterlacePDSCH-Common-r16) and the cell usable bandwidth contains only 1 RB set (configured by intraCellGuardBandUL-r16) whose bandwidth is beyond a pre-defined threshold cannot happen at the same time. That is, the two configurations cannot be allocated to the UE at the same time. Otherwise, the PUCCH resource allocation will have issue. In some embodiments, this issue may be dealt in the specifications in the future as follows: When a UE is provided with useInterlacePUCCH-Common-r16, or useInterlacePUSCH-Common-r16, or useInterlacePDCCH-Common-r16, or useInterlacePDSCH-Common-r16, the UE is not expected to be provided with intraCellGuardBandUL-r16 that indicates a zero bandwidth intra-cell guard band.

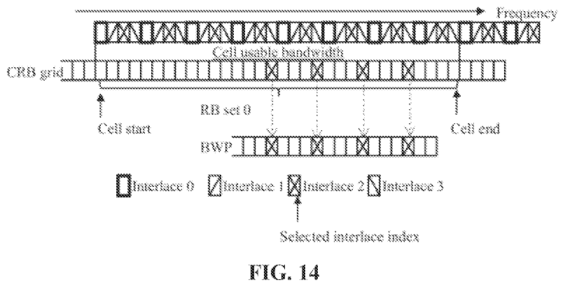

FIG. 14 illustrates PUCCH resource allocation determination according to another embodiment of the present disclosure. In some embodiments, on the other hand, if the cell usable bandwidth only contains 1 RB set and its bandwidth does not exceed the pre-defined threshold, as illustrated in FIG. 14, the PUCCH can still use the interlace structure and the RB set index for the PUCCH resource allocation is within the intersection between the RB set with index 0 of the cell usable bandwidth and the active UL BWP.

Commercial interests for some embodiments are as follows. 1. determining a frequency location of a physical uplink control channel (PUCCH). 2. providing PUCCH resource allocation determination. 3. providing a good communication performance. 4. providing a high reliability. 5. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use. AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in the 5G NR unlicensed band communications. Some embodiments of the present disclosure propose technical mechanisms.

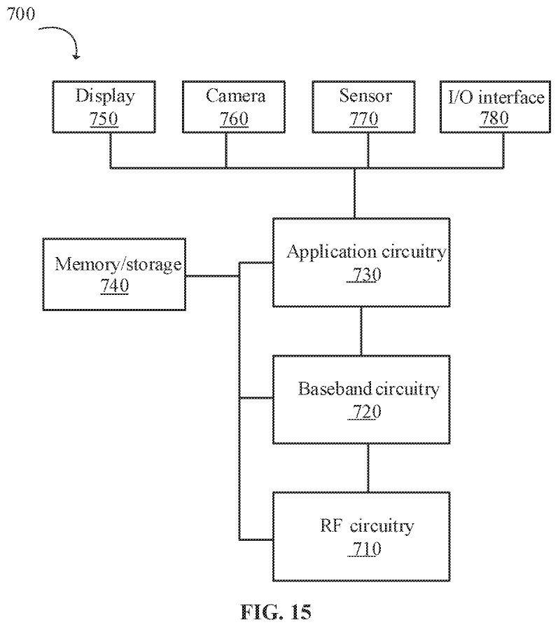

FIG. 15 is a block diagram of an example system 700 for wireless communication according to an embodiment of the present disclosure. Embodiments described herein may be implemented into the system using any suitably configured hardware and/or software. FIG. 15 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental states and/or location first information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the state of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method of communication of a user equipment (UE), comprising:
receiving, by a UE, a first information and a second information, wherein the first information and the second information are used to determine a frequency location of a physical uplink control channel (PUCCH).

2. The method of claim 1, wherein the first information is in a radio resource control (RRC) configuration.

3. The method of claim 1, wherein the first information comprises at least two configurations with corresponding configuration indexes.

4. The method of claim 3, wherein each configuration of the first information comprises a first parameter, the first parameter is used to indicate a interlace index corresponding to a selected interlace.

5. The method of claim 4, wherein each configuration of the first information further comprises a second parameter, the second parameter is used to indicate a resource block (RB) set index corresponding to a selected RB set.

6. The method of claim 1, wherein the second information is in a downlink control information (DCI).

7. The method of claim 3, wherein the second information comprises a first indication field, the first indication field is used to select one of the configuration indexes of the first information.

8. The method of claim 5, wherein the frequency location of the PUCCH is determined by overlapped RBs between the selected interlace and the selected RB set.

9. The method of claim 5, wherein the RB set index is an index of the selected RB set in a cell usable bandwidth of a cell.

10. The method of claim 9, wherein the RB set index in the cell usable bandwidth has indexes staring from 0 to X−1 in an ascending order in a frequency domain, where X is a number of RB sets in the cell usable bandwidth.

11. A user equipment (UE), comprising:
a memory;
a transceiver; and
a processor coupled to the memory and the transceiver;
wherein the processor is configured to control the transceiver to receive a first information and a second information, wherein the first information and the second information are used to determine a frequency location of a physical uplink control channel (PUCCH).

12. The UE of claim 11, wherein the first information is in a radio resource control (RRC) configuration.

13. The UE of claim 11 wherein the first information comprises at least two configurations with corresponding configuration indexes.

14. The UE of claim 13, wherein each configuration of the first information comprises a first parameter, the first parameter is used to indicate a interlace index corresponding to a selected interlace.

15. The UE of claim 14, wherein each configuration of the first information further comprises a second parameter, the second parameter is used to indicate a resource block (RB) set index corresponding to a selected RB set.

16. The UE of claim 15, wherein the frequency location of the PUCCH is determined by overlapped RBs between the selected interlace, the selected RB set, and an active uplink bandwidth part.

17. The UE of claim 15, wherein the RB set index is an index of the selected RB set in the active uplink bandwidth part.

18. The UE of claim 17, wherein the RB set index in the active uplink bandwidth part has indexes from 0 to Y−1 in an ascending order in a frequency domain, where Y is a number of the RB sets in the active uplink bandwidth part.

19. The UE of claim 17, wherein the selected RB set in the active uplink bandwidth part is derived from RB sets in a cell usable bandwidth of a cell and the active uplink bandwidth part.

20. The UE of claim 19, wherein the RB set index and locations of the RB sets in the cell usable bandwidth are obtained based on a third parameter and the cell usable bandwidth.
